(19) United States
(12) Patent Application Publication
(10) Pub. No.: US 2006/0124000 A1
(43) Pub. Date: Jun. 15, 2006

(54) System for dehulling by cylinder provided with a pneumatic conveyor

(75) Inventor: Frank-Otto Gorlitz, Braunschweig (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Buhler AG, Uzwil (CH)

(21) Appl. No.: 10/534,827

(22) PCT Filed: Oct. 14, 2003
(86) PCT No.: PCT/CH03/00668

§ 371 Date: Jan. 9, 2006

(30) Foreign Application Priority Data
Nov. 13, 2002 (DE) 102 53 099.8

(51) Int. Cl. A47J 17/00

(52) U.S. Cl. 99/584

(57) ABSTRACT

The invention relates to a system for dehulling by cylinders, in particular to a system for dehulling grain fruits. An exemplary system includes a pair of rubber cylinders arranged in a housing. The product supply is carried out with the aid of a chute in a pneumatic conveyor which operates in a pressure mode and can be embodied in the form of a conveyor tube provided with an elbow. The system can make it possible to obtain a better supply performance and reduced breaking propensity.

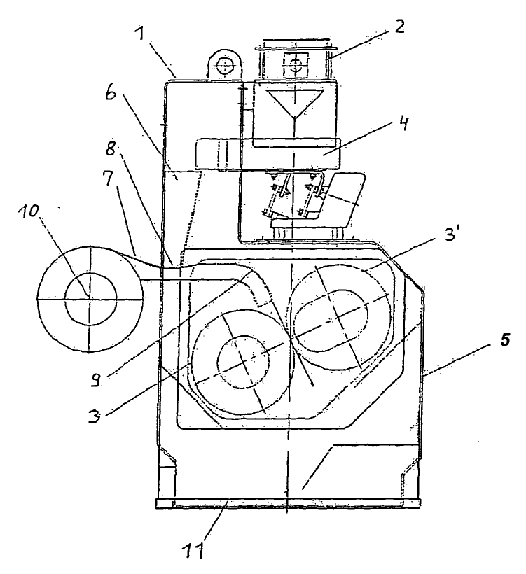

The invention relates to a roll peeler, particularly a roll peeler for cereals, preferably a rubber roll peeler for peeling rice and other cereals, which especially the raw grain peels are taken out with, as per the title of the patent claim 1.

This type of roll peelers and rubber roll peelers are known for example from the DEOS 2705334. They have a pair of rubber cylinders with pneumatically adjustable roll pressure. The raw rice is supplied from above into the gap between the rolls arranged horizontally in a pivoting carrier. The WO-A-02/064256 shows a corresponding feeding device.

Deviating from the abovementioned device, the GB-PS 797372 proposes a feeding chute pivoting at a fulcrum whose movements depend on the wear-induced gap displacement, in order to compensate for the displacement of the gap between the rolls due to wear and tear of the roll surfaces. The rolls are diagonally arranged and the chute is arranged vertically or close to vertically to the assumed connecting line of the roll axes. Apart from the tracking ability of the feeding chute, a good peeling performance with less grain breakage is achieved; the grains are fed into the mechanism via a defined thin and accelerated product veil across the full width of the roll. A similar embodiment shows for example the EP-A-820814, where a gap displacement of ±10 mm is said to be adjustable. It claims to feed the corns to be peeled in a single layer.

In case of incomplete product veil, however, the single-layer feeding of grains involves augmented risks of roll wear and tear and higher grain breakage. Too low feeding speed, on the other hand, leads to multi-layering and to increased grain breakage. Moreover, there are technical and economical limits for the length of the chutes.

The invention avoids the disadvantages of the state-of-the-art technology and increases the feeding capacity of roll peelers providing in addition a reduced risk of grain breakage. The task is solved with the distinctive characteristics of the patent claim 1.

The invention is based on the knowledge that the possible circumferential speed of the rolls (approximately 10-20 m/s) allows a multiple of the speed being used with state-of-the-art technology to feed the grains to be peeled. This is not possible with simple fall acceleration or chute, however.

As per invention, it is therefore suggested to arrange a pneumatic feeding device in front of the roll gap; the grains to be peeled are first fed into this feeding device by means of a conveying device, e.g. a chute or an acceleration pipe. It is possible to easily reach feeding speeds up to approximately 20 m/s (or more, if a further increase of the circumferential speed of the rolls is accomplished).

Besides, cooling of the pressurized rolls via the pneumatic feed is achieved, thereby avoiding a reduction of roll service life despite a significant increase in throughput. Moreover, a separate roll cooling system is not necessary.

Preferred embodiments are disclosed in the sub-claims. The cross-section of the feeding device may be either rectangular or tubular; in order to generate a partial vacuum, a venturi tube reduces the diameter of the feed at the grain intake point.

The grains to be peeled can be fed into the pneumatic feeding device by means of pressure or suction; product quantity should be adjusted to supply speed.

The pneumatic feeding device may be pivoted for the defined supply of the grains to be peeled into the roll gap; this mounting takes into account the displacement of the roll gaps due to roll wear and tear. Moreover, the feeding device should be curved in order to generate a separation effect that allows a single-layer supply of the grains. The feeding device is a tubular pipe and preferentially has a rectangular cross-section whose inner width corresponds to the roll length. In order to avoid counter-pressure, an aspiration connection should be provided on the housing of the roll peeler, preferably at the top of the housing to avoid suction of peels.

The invention includes the following main advantages:
The feed speed is largely independent of the length of a chute
The roll peeler can be more compact, especially in height
Optimization of the roll cooling
Increased performance of the roll peeler
Reduction in breakage increase in case of higher throughput

These and other aspects of the invention are apparent from and will be elucidated with reference to the embodiments and drawing described in details hereinafter. The drawing shows a roll peeler in a simplified sectional view.

A rubber roll peeler 1 with a pair of rubber rolls 3, 3′, which are arranged in a housing 5, has an inlet 2 for the rice to be peeled with one vibratory feeding device 4 arranged under it. Downstream of the vibratory feeder 4, an inlet funnel 6 with an inclined chute is arranged in a way that its outlet is ending just above the narrowing of the venturi tube 8 of a feed pipe 7. The product moves onto the chute and into the feed pipe 7. The feed pipe 7 has a rectangular cross-section; its one end is connected to a pressure ventilator 10 having an elastic transition. The venturi tube 8 enables a partial vacuum and therefore an increase in product speed. Due to the partial vacuum, the product is sucked into the feed pipe 7. Alternatively, for example an inlet sluice with fine chamber division or a corrugated roll with elastic cover strip may also be used. The other end of the feed pipe 7 ends near the gap between the rolls 3, 3′.

The rolls 3, 3′ are arranged horizontally or diagonally; the end of the feed pipe 7 is arranged in the gap between rolls in a way that an assumed extension is running more or less vertically to the connection line between the axes of the rolls 3, 3′. The rolls 3, 3′ are equipped with the known lever control of the applicant.

The form of the inner width of this end of the feed pipe 7 corresponds to the roll length. Thereby, contact pressure of the rolls 3, 3′ is distributed more evenly, and so is wear and tear of the rolls. In order to achieve the arrangement in the roll gap in the abovementioned manner, the feed pipe 7 in this area is shaped as a deflector arc 9. Thus, a separation effect is generated and the product is fed in a single layer into the roll gap on the outside of the deflector arc 9. Therefore, the deflector arc 9 must consist of wear-resistant material.

The inner height of the feed pipe 7 can be adjusted in such a way that, depending on delivery volumes of the pressure ventilator 10, air speed flow is corresponding to approx. 10-20 m/s. The supplied air also serves as a coolant for the rolls 3, 3′. An inner height of the feed pipe of 40 mm and a width of 254 mm require approximately 4.4 m³/min air. If stronger roll cooling is necessary, increasing the height of the feed pipe 7 may increase the amount of air.

In order to be able to feed the rice to be peeled exactly into a roll gap changing due to wear and tear, the feed pipe is mounted on a swivelling/pivoting mount and equipped with an elastic transition between the pressure ventilator 10 and the feed pipe 7 as to allow the wandering roll gap to be tracked.

Above the rolls 3, 3′ an aspiration connection (not displayed) is provided on the housing 5 in order to avoid a counter-pressure on the outlet of the deflector arc 9 of the feed pipe 7. Here, at least as much air is sucked out as supplied. The abovementioned arrangement of the aspiration connection also helps avoiding a suction of the detached peels.

A peel-separator (not displayed) is arranged below the outlet 11 for the rice/peels mixture.

### REFERENCE SYMBOLS

1 Rubber roll peeler
2 Inlet
3 Roll
3′ Roll
4 Vibratory feeder
5 Housing
6 Inlet funnel
7 Feed pipe
8 Venturi tube
9 Deflector arc
10 Pressure ventilator
11 Outlet

1-7. (canceled)

8. Roll peeler, for peeling material, comprising:
at least one pair of rolls in a housing;
a feeding device for the material to be peeled with a diagonally arranged feeding device;
a pneumatic conveying device provided between the feeding device and the roll gap;
a feed pipe; and
an air connection, wherein a lower end of the feeding device is constructed as a chute, and is arranged above a venturi tube of the feed pipe, and wherein an aspiration connection is provided approximately on roll level or above the rolls.

9. Roll peeler as per claim 8, wherein the feed pipe located in front of the roll gap is built as a deflector arc whose assumed extension line is approximately vertical to the connecting line of the rolls' axes.

10. Roll peelers as per claim 8, wherein the feed pipe can be swivelled or pivoted.

11. Roll peelers as per claim 8, wherein the feed pipe's cross-section is rectangular and its inner width corresponds to a length of the.

12. Roll peeler as recited in claim 8, wherein the rolls are rubber rolls, and the material is cereal.

13. Roll peelers as per claim 9, wherein the feed pipe can be swivelled or pivoted.

14. Roll peelers as per claim 8, wherein the feed pipe's cross-section is rectangular and its inner width corresponds to a length of the rolls.
